(19) United States
(12) Patent Application Publication
(10) Pub. No.: US 2025/0228228 A1
(43) Pub. Date: Jul. 17, 2025

(54) FISH STORAGE AND CARRYING BAG

(71) Applicant: Stephen Hooper, Vancouver (CA)

(72) Inventor: Stephen Hooper, Vancouver (CA)

(21) Appl. No.: 18/413,109

(22) Filed: Jan. 16, 2024

(51) Int. Cl. A01K 97/20

(52) U.S. Cl. CPC A01K 97/20

(57) ABSTRACT

A fish storage and transport bag that is employed for providing both wet storage of a caught fish as well as transportation thereof. The fish storage and transport bag of the present invention includes a body that is rectangular in shape having a first end and a second end wherein the body is formed to create an interior volume of suitable size to accommodate a fish therein. The second end of the body is manufactured from mesh material wherein the mesh material facilitates introduction of water into the interior volume of the body upon the fish storage and transport bag being submerged into water. The present invention includes a closure mechanism having a first cross strap and a second cross strap wherein rolling of the body and alignment thereof provides closure of the opening of the body at the first end thereof. An anchor line is secured to the body.

### FIELD OF THE INVENTION

The present invention relates generally to fishing accessories, more specifically but not by way of limitation, a portable bag utilized to store fish subsequent being caught wherein the bottom of the outer shell includes mesh to permit water to enter the interior volume of the bag. The portable bag further includes a liner that is releasably secured within the interior volume that is employed for transportation of the fish.

### BACKGROUND

Millions of individuals routinely engage in fishing as a recreational activity. There are numerous different styles and types of fishing which are segregated into two main categories of saltwater and freshwater fishing. Saltwater fishing occurs in oceans, bays and estuaries and can be performed either from a boat or from shore. The type of fishing gear varies based upon the type of fish being targeted. Most saltwater anglers employ coolers and similar style devices to store the caught fish and transport to a desired location.

Many freshwater anglers will fish in streams and rivers and may traverse many miles along a river or stream as they explore for potential areas to catch fish. As this type of fishing involves traversing distances, it is not common for these anglers to transport items such as conventional coolers. Many rivers and streams have a water temperature that is low enough to safely store caught fish for many hours. Commonly, anglers will either use gill lines or similar item to secure a fish once caught and allow the fish to float in the river or stream. Some anglers will find or build small capture pools to deposit fish into subsequent catching the fish. While these techniques do provide the necessary functionality, they are deficient in assisting of the transportation of fish as well as providing an ability to conceal that a fish has been caught.

Accordingly, there is a need for a portable fish storage and transportation bag that is operable to provide wet storage for fish and further provide an ability to transport caught fish to a desired location in a manner that inhibits leaks therefrom.

### SUMMARY OF THE INVENTION

It is the object of the present invention to provide a fish storage and transportation bag wherein the present invention includes a body that is manufactured from a suitable material such as but not limited to polyvinyl chloride.

Another object of the present invention is to provide a transportable bag that is configured to provide wet storage of caught fish wherein the body includes a first end and a second end and is generally rectangular in shape.

A further object of the present invention is to provide a fish storage and transportation bag wherein the body is formed to have an opening proximate the first end thereof.

Yet a further object of the present invention is to provide a transportable bag that is configured to provide wet storage of caught fish wherein the second end of the body is manufactured from a mesh material wherein the mesh material permits water to flow into the interior volume of the transportable bag.

Still another object of the present invention is to provide a fish storage and transportation bag wherein the present invention further includes an interior liner that is configured to be removable.

An additional object of the present invention is to provide a transportable bag that is configured to provide wet storage of caught fish wherein the body further includes an integrated closure mechanism secured to the first end thereof.

Yet a further object of the present invention is to provide a fish storage and transportation bag wherein the body further includes an ability to add a tether to the first end of the body.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention in use for fish storage; and

FIG. 2 is a detailed view of the buckle of the closure mechanism of the present invention; and

FIG. 3 is a detailed view of the closure mechanism and the first end of the body in a closed position.

### DETAILED DESCRIPTION

Referring now to the drawings submitted herewith, wherein various elements depicted therein are not necessarily drawn to scale and wherein through the views and figures like elements are referenced with identical reference numerals, there is illustrated a fish storage and transport bag 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the fish storage and transport bag 100 includes a body 10 wherein the body 10 includes a first end 11 and second end 12 and wherein the body 10 is generally rectangular in shape. While the preferred embodiment of the present invention is rectangular in shape, it is contemplated within the scope of the present invention that the body 10 could be provided in alternate shapes and sizes. The body 10 is manufactured from a durable material such as but not limited to polyvinyl chloride. In a preferred embodiment of the present invention the body 10 is manufactured from an eighteen-ounce weight polyvinyl chloride fabric. While the body can be manufactured in various lengths, in a preferred embodiment of the present invention that body 10 has a length of thirty-seven inches and further is expandable to have a diameter when opened of twenty-four inches.

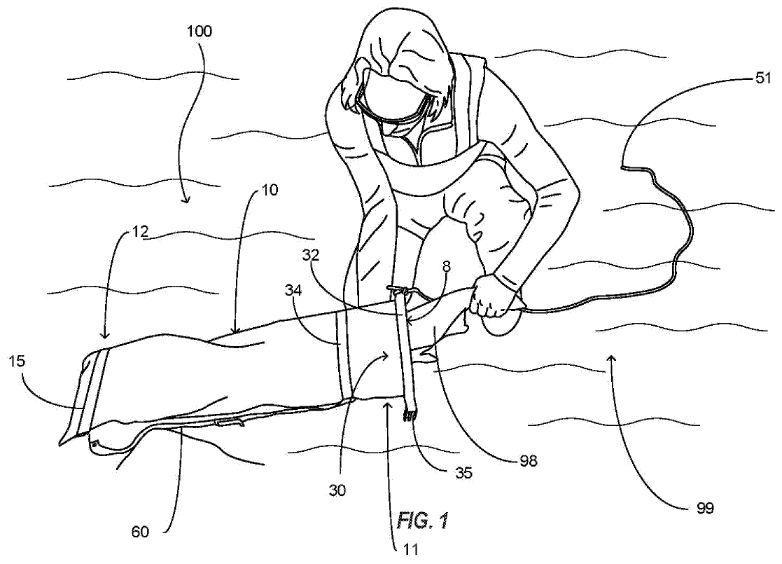

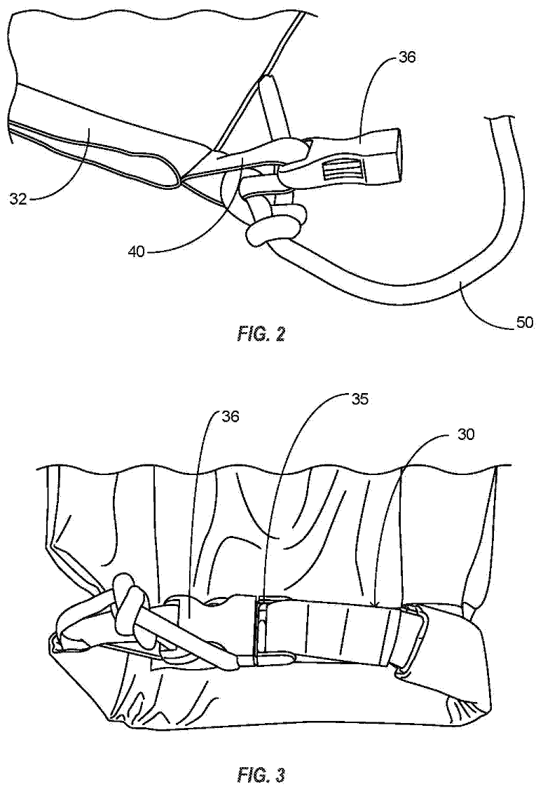

The second end 12 includes mesh portion 15 wherein the mesh portion 15 comprises the bottom of the body 10. The mesh portion 15 is manufactured from material such as but not limited to nylon mesh wherein the mesh portion 15 permits water to flow into the interior volume of the body 10. During use for wet fish storage, as is illustrated herein in FIG. 1, the body 10 is submersed in an exemplary river 99 and the mesh portion 15 permits water to enter the interior volume of the body 10 and further facilitates an ability to vent water and other debris from the interior volume of the body 10. The interior volume of the body 10 is substantially filled with water providing cool wet storage for the fish 98. While a mesh portion 15 comprises the bottom of the body 10 in a preferred embodiment, it is contemplated within the scope of the present invention that the body 10 could be provided in alternate configurations in order to facilitate entry of water into the interior volume of the body 10. By way of example but not limitation, the body 10 could have apertures formed in various locations so as to facilitate introduction of water into the interior volume of the body 10.

The fish storage and transport bag 100 includes a closure mechanism 30 that is integrally secured to the first end 11 of the body 10. The closure mechanism 30 includes a first cross strap 32 and a second cross strap 34 that are secured across one side of the body 10 employing suitable techniques such as but not limited to stitching. The first cross strap 32 includes a first keeper 35 and a second keeper 36 secured thereto at opposing ends thereof. The first keeper 35 and second keeper 36 are configured to be mateably coupled so as to provide closing of the body 10 as illustrated herein in FIG. 3. It should be understood within the scope of the present invention that the fish storage and transport bag 100 could employ numerous types of fasteners for the first keeper 35 and second keeper 36. By way of example but not limitation, the first keeper 35 and second keeper 36 could be a parachute buckle.

The closure mechanism 30 is configured to facilitate rolling of the first end 11 of the body 10 so as to provide closure of opening 8. The body 10 is rolled from the first end 11 toward the second end 12 wherein the first cross strap 32 is rolled downward to a position wherein the first cross strap 32 is superposed and aligned with the second cross strap 34. Ensuing alignment of the first cross strap 32 and second cross strap 34, the first keeper 35 and second keeper 36 are mateably connected in order to maintain the body 10 in a closed position. It is contemplated within the scope of the present invention that the closure mechanism 30 is operable to provide an airtight seal, when utilizing a liner, ensuing being placed in the closed position.

The first cross strap 32 includes end loop member 40. End loop member 40 is manufactured from the same material as the first cross strap 32 and is integrally formed therewith. The end loop member 40 includes second keeper 36 secured thereto and further provides an element to secure anchor line 50. Anchor line 50 is employed to the secure the body 10 in a desired position in river 99. The end 51 distal to the body 10 can be secured to a suitable anchoring element such as but not limited to a rock or log. It should be understood within the scope of the present invention that the anchor line 50 can be provided in alternate lengths. The body 10 has operably coupled thereto a strap member 60. Strap member 60 is employed to carry the fish storage and transport bag 100 on a user's shoulder. The strap member 60 is manufactured from suitable durable material and is adjustable in length. While not specifically illustrated herein, the fish storage and transport bag 100 includes a removable liner. The removable liner is inserted into the interior volume of the body 10 and is utilized when a user of the fish storage and transport bag 100 desires to remove the fish storage and transport bag 100 from the water and transport fish to a desired location. The removable liner is inserted into the interior volume of the body 10 and subsequently fish are placed therein. The removable liner is manufactured from a suitable material such as but not limited to plastic.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A fish storage and transport bag that is configured to provide wet storage of fish as well as transport thereof wherein the fish storage and transport bag comprises:
a body, said body having a first end and a second end, said body being formed to have an interior volume, said body having an opening at said first end, said body further having a mesh portion, said mesh portion being formed in said second end of said body, said mesh portion being operable to facilitate introduction and exit of water into the interior volume of said body subsequent submersal of said body into water;
a closure mechanism, said closure mechanism being secured to said body proximate said first end, said closure mechanism having a first cross strap and a second cross strap, said closure mechanism having a first keeper and a second keeper, said first keeper being operably coupled to said first cross strap at a first end of said first cross strap;
an anchor line, said anchor line having a first end and a second end, said first end of said anchor line being secured proximate to said first end of said body; and
wherein said body is configured to be rolled in a direction from said first end towards said second end wherein said first cross strap is positioned so as to be aligned with said second cross strap prior to coupling of said first keeper and said second keeper.

2. The fish storage and transport bag that is configured to provide wet storage of fish as well as transport thereof as recited in claim 1, and further including an end loop member said end loop member being contiguous with a second end of said first cross strap member.

3. The fish storage and transport bag that is configured to provide wet storage of fish as well as transport thereof as recited in claim 2, wherein said second keeper is secured to said end loop member.

4. The fish storage and transport bag that is configured to provide wet storage of fish as well as transport thereof as recited in claim 3, wherein said first end of said anchor line is secured to said end loop member.

5. The fish storage and transport bag that is configured to provide wet storage of fish as well as transport thereof as recited in claim 4, wherein said body is manufactured from eighteen ounce polyvinyl chloride fabric.

6. The fish storage and transport bag that is configured to provide wet storage of fish as well as transport thereof as recited in claim 5, and further including a removable liner, said removable liner configured to be releasably secured within said interior volume of said body.

7. The fish storage and transport bag that is configured to provide wet storage of fish as well as transport thereof as recited in claim 6, and further including a strap member, said strap member extending generally a full length of said body, said strap member operable to assist in transport of the fish storage and transport bag.

8. The fish storage and transport bag that is configured to provide wet storage of fish as well as transport thereof as recited in claim 7, wherein said body is rectangular in shape.
